(19) United States
(12) Patent Application Publication
(10) Pub. No.: US 2023/0394987 A1
(43) Pub. Date: Dec. 7, 2023

(54) SYSTEM AND METHOD FOR A METHOD OF RETENTION OF LEARNED INFORMATION BASED ON THE PRESENTATION OF QUESTIONS ACCORDING TO THE DEGREE OF SUCCESS OBTAINED IN ANSWERING THEM

(71) Applicant: Jean-Louis Vill, Quebec (CA)

(72) Inventor: Jean-Louis Vill, Quebec (CA)

(73) Assignee: Jean-Louis Vill, Quebec (CA)

(21) Appl. No.: 17/832,623

(22) Filed: Jun. 4, 2022

(51) Int. Cl. G09B 7/08; G09B 7/04

(52) U.S. Cl. CPC G09B 7/08; G09B 7/04

(57) ABSTRACT

The present invention relates to a method of information retention of learned material which displays a question on the user's screen at regular intervals, according to certain criteria, including a weighting system. This process consists of electronically reading the questions that will be asked to the user, shuffling the questions, sorting the questions according to criteria or a point system, preparing the list of questions, displaying the most popular questions, one after the other, allowing a maximum time if necessary to answer the question, adding or subtracting zero, one, or more points for each answer given by the user, linking and saving the point(s) assigned with the question asked or to the group to which the choice question belongs or to the question linked to the answer or to the group to which the question linked to the answer belongs and to determine when the next question will be displayed.

### BACKGROUND/SUMMARY

### Field of the Invention

The present invention relates to a method of information retention for learned material that displays questions to the user according to the degree of success of previously obtained answers.

### Background of the Invention

According to research launched by James Madison University¹, the following is the retention efficiency rate of different learning methods: ¹ How Memory Works, James Madison University
1. Listening: 5%
2. Reading: 10%
3. Audiovisual: 20%
4. Demonstration: 30%
5. Discussion groups: 50%
6. Practice: 75%
7. Teaching Others and Using Information Immediately: 90% There are many ways to learn—most of which are based on acquiring know-how, including material that must be committed to memory or learned by rote. For example, memorizing the periodic table may see an individual using repetition in different ways to learn the symbols, names, and atomic numbers. However, in learning a foreign language, much more involvement is needed; most people can't just memorize a new language and its vocabulary. Learning new languages focuses on pronunciation, listening, writing, reading, and practicing. And through continual lessons, new vocabulary will be obtained. Current methods of learning a language are not designed to learn and retain vocabulary, and the ‘forgetting curve’ of the vocabulary learned in lessons is significant. This is also true in other fields wherein the acquisition of knowledge is based on memorizing words—words dedicated to a profession, formulas, principles, concepts, etc. What happens is that a certain amount of information previously learned is forgotten as time goes on.

The problem of forgetting is due to three factors.
1. Time required to review a lesson;
2. Lack of sufficient repetition to imprint the lesson in the individual's long-term memory;
3. Wasted time reviewing words, formulas, concepts, etc. that have already been mastered, which significantly reduces the effectiveness of long-term retention of knowledge learned;

Problem number 1 is that a lot of people take time to learn, but very few are willing to invest time to review the matter seriously;

Problem number 2 is that of the people who take time to revise, very few revise more than once. However, revisions must be attempted several times and at different times to be effective;

Problem number 3 is that when a review is done, there is unproductive time to review the already memorized material through the one that needs to be memorized which considerably reduces the percentage of effectiveness of revision carried out.

The problems listed above are credible while still approachable and solvable using tried and tested learning methods and through applications dedicated to learning concepts that require memorization of words, words dedicated to a profession, formulas, principles, concepts, etc.

### OBJECT OF THE INVENTION

An object of the present invention is therefore to provide an improved method and device for a method of retention of learned information based on the presentation of questions according to the degree of success obtained in answering them.

### SUMMARY OF THE INVENTION

In the following text, the epithet “notification” applies to an electronic notification that appears outside of an application's user interface. These notifications allow you to perform an action directly from the notification itself. These notifications appear on the user's screen and disappear after a certain delay while remaining accessible. These notifications can be in the form of text, image, audio, animation, video, or audiovisual type;

The object of the present invention is to provide an automated and improved method of information retention for learned material. It is part of a review context and therefore requires a bank of questions previously constructed and saved following a course received. It allows individuals to implement writing, listening, reading, audiovisual and practice during a predetermined period;

In the first general aspect, the invention relates to an information retention method, operating under a computer system, which regularly displays a question on the user's screen through a notification, according to a weighting system. This process consists of electronically reading the questions that will be asked to the user, shuffling the questions, sorting the questions according to a system of criteria or points, preparing the list of questions, displaying the questions beforehand, sorting them on the user's screen in the form of a notification, to add or subtract zero, one, or more points for each answer given by the user, to link and save the point(s) assigned with the question asked, to display the answer to the user, and to determine when the next question will be displayed;

At regular intervals, there is a delay of zero to several seconds following a given answer or regardless of an answer being given;

Electronically reading the questions to be asked implies that the questions and the criteria associated with them are read from a storage medium accessible by the computer system;

Sorting questions according to a point system involves sorting questions based on their criteria or scores;

To view questions implies that the user will see only one question at a time, from the first to the last according to the sorting order and the number of questions contained in a learning session;

Adding or subtracting zero, one, or more points involves adding or subtracting a score from zero, one, or more points depending on the user's answer. The accumulation of these additions and subtractions will be found in a predetermined interval of minimum and maximum values. It is the ratio of the points accumulated on the maximum value which indicates the level of retention of the acquired knowledge;

Determining when the next question will be displayed implies that depending on the chosen operating mode, the next question can be displayed only after the user has answered the previous question or after a certain delay which will replace the previous question even if the user has not answered;

In a second general aspect, the invention relates to an information retention method, operating under a computer system, which regularly displays a multiple-choice question on the user's screen through a notification, according to a weighting system. The answer choices offered are a subset of the answers to the other questions in the database, sharing the same criteria as the multiple-choice question. This process consists of electronically reading the multiple-choice questions that will be asked to the user, shuffling the questions, sorting the multiple-choice questions according to a system of criteria or points, preparing the list of questions in multiple-choice, displaying the multiple-choice questions beforehand, sorting the questions on the user's screen as a notification, replacing the multiple-choice question in the list of current multiple-choice questions at the user's request, to add or subtract zero, one, or more points for each answer given by the user, to link and save the point(s) assigned with the question asked, to link and save the subtracted point(s) with the question to which the given answer corresponds in the event of a wrong answer, to display the answer to the user and the questions associated with the other proposed answer choices, to determine when the next question will be displayed;

At regular intervals, a delay of zero to several seconds is given following an answer or regardless of an answer being given;

Electronically reading the multiple-choice questions to be asked implies that the questions and the associated criteria are read from a storage medium accessible by the computer system;

Sorting multiple-choice questions according to a point system involves sorting the questions based on their criteria or scores;

Displaying multiple-choice questions implies that the user will see only one question at a time from the first to the last according to the sorting order and the number of questions contained in a learning session;

Adding or subtracting zero, one, or more points involves adding or subtracting a score from zero, one, or more points depending on the user's answer. The accumulation of these additions and subtractions will be found at a predetermined interval of minimum and maximum values. It is the ratio of the points accumulated on the maximum value which indicates the level of retention of the acquired knowledge;

In the third general aspect, the invention relates to an information retention method, operating under a computer system, which displays a question on the user's screen, according to a weighting system. This process consists of electronically reading the questions that will be asked to the user, shuffling the questions, sorting the questions according to a point system, preparing the list of questions, displaying the questions previously sorted one by one on the user's screen, granting a maximum time if necessary to answer the question, adding or subtracting zero, one, or more points for each answer given by the user, linking and saving the point(s) awarded with the question asked, and displaying the next question following a given answer or at the end of the countdown;

Electronically reading the questions to be asked implies that the questions and the criteria associated with them are read from a storage medium accessible by the computer system;

Display on the user's screen involves a display other than a notification, such as in the workspace of an application, web page, etc.;

One by one implies that the user will see only one question at a time from the first to the last according to the sort order and the number of questions contained in a learning session;

Granting a maximum time-out if necessary to answer a question means that a question may, but not necessarily, have an automated time-out after which the user will no longer be able to answer that question;

Adding or subtracting zero, one, or more points involves adding or subtracting a score from zero, one, or more points depending on the user's answer. The accumulation of these additions and subtractions will be found in a predetermined interval of minimum and maximum values. It is the ratio of the points accumulated on the maximum value which indicates the level of retention of the acquired knowledge;

In the fourth general aspect, the invention relates to an information retention method, operating under a computer system, which displays on the user's screen a question belonging to a group of questions sharing the same criteria according to a weighting system. This process consists of electronically reading the questions that will be asked to the user, shuffling the questions, sorting the questions according to a point system, preparing the list of questions, displaying one by one on the user's screen the previously sorted questions, allowing a maximum time if necessary to answer the question, adding or subtracting zero, one, or more points for the answer to the group of questions to which the question belongs, linking and saving the point(s) assigned to the group of questions to which the question belongs, and displaying the next question following a given answer or at the end of the countdown;

Electronically reading the questions to be asked implies that the questions and criteria associated with them are read from a storage medium accessible by the computer system;

Display on the user's screen involves a display, other than a notification, such as in the workspace of an application, web page, etc.;

One by one implies that the user will see only one question at a time. From the first to the last according to the sort order and the number of questions contained in a learning session;

Granting a maximum time-out if necessary to answer a question means that a question may, but not necessarily, have an automated time-out after which the user will no longer be able to answer that question;

Adding or subtracting zero, one, or more points implies an addition or a subtraction of a score of zero, of one or more points to the group of questions according to the answer of the user. The accumulation of these additions and subtractions will be found in a predetermined interval of minimum and maximum values. It is the ratio of the cumulative points on the maximum value for a given group of questions that indicates the level of retention of the acquired knowledge;

In the fifth general aspect, the invention relates to a method of information retention for learned information, operating under a computer system, which regularly displays on the user's screen a question in the form of a notification belonging to a group of questions sharing the same criteria according to a weighting system. This process consists of electronically reading the questions that will be asked to the user, shuffling the questions, sorting the questions according to a point system, preparing the list of questions, displaying the questions previously sorted on the user's screen in the form of a notification, adding or removing zero, one, or more points for each answer given by the user to the group of questions to which the question belongs, and determining when the next question will be displayed;

At regular intervals involves a delay of zero to several seconds following a given answer or regardless of an answer being given;

Electronically reading the questions to be asked implies that the questions and the criteria associated with them are read from a storage medium accessible by the computer system;

Sorting questions according to a point system involves sorting questions according to their criteria or scores;

Showing the questions one by one implies that the user will see only one question at a time from the first to the last according to the sorting order and the number of questions contained in a learning session;

Adding or subtracting zero, one, or more points implies an addition or a subtraction of a score of zero, of one or more points to the group of questions according to the user's answer. The accumulation of these additions and subtractions will be found in a predetermined interval of minimum and maximum values. It is the ratio of the cumulative points on the maximum value for a given group of questions that indicates the level of retention of the acquired knowledge;

Determining when the next question will be displayed implies that, depending on the chosen operating mode, the next question can be displayed only after the user has answered or after a certain delay and replace the previous question even if the user has not answered.

### DESCRIPTION

### Brief Description of the Drawings

In the accompanying drawings:

FIG. 1 is a flowchart of a learned information retention method that displays questions to the user according to the degree of success of previously obtained answers with a countdown timer;

FIG. 2 is a flowchart of a learned information retention method that displays multiple-choice questions to the user according to the degree of success of previously obtained answers with a countdown timer;

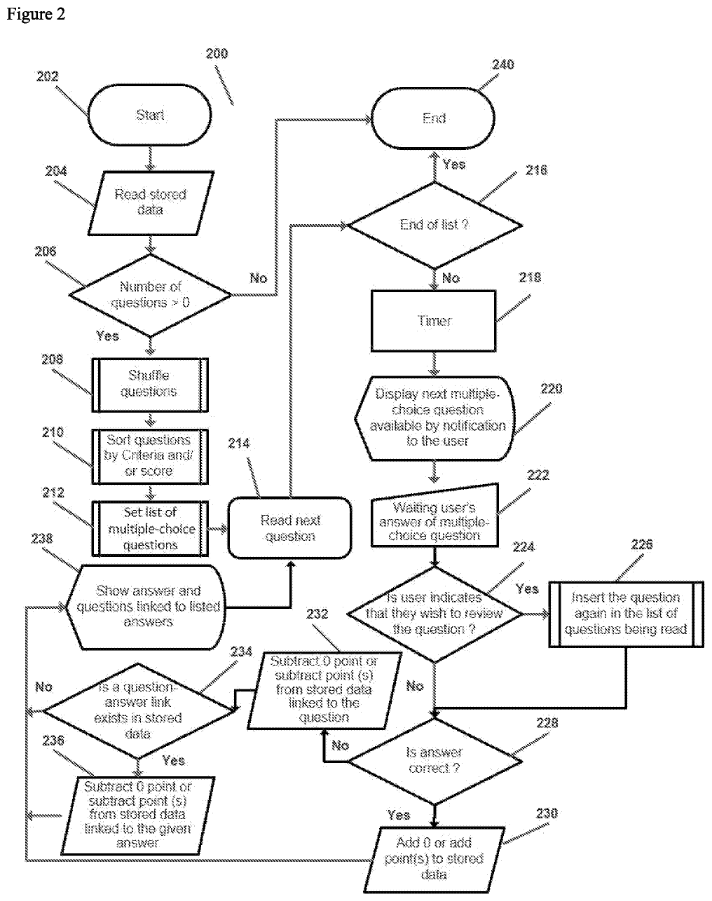

FIG. 3 is a schematic diagram of a mobile computing device for executing a program element implementing a learned information retention method that displays questions to the user according to the degree of success of previously obtained answers;

FIG. 4 is a schematic diagram of a computing device used for executing a program element and implementing a learned information retention method that displays questions to the user according to the degree of success of previously obtained answers;

FIG. 5 is a schematic diagram of a client-server device for executing a program element implementing a learned information retention method that displays questions to the user according to the degree of success of previously obtained answers.

### DETAILED DESCRIPTION

In the following text, the word “score” means a system of numbers or other notations used to assess the retention rate. The minimum score and the maximum score are bounded by predetermined minimum and maximum values;

In the following text, the epithet “notification” applies to an electronic notification that appears outside of an application's user interface. These electronic notifications allow actions to be taken directly from the electronic notification itself. These electronic notifications appear on the user's screen and disappear after a certain delay while remaining accessible. These notifications can be of text, image, audio, animation, video, or audiovisual types;

The invention is part of a review context and requires a bank of questions previously constructed and saved following teaching received;

In the first aspect, the invention is applied through a notification wherein the user decides to display the next question.
a. Pre-register a bank of questions including their criteria, the group to which they belong, their answers, and the scores;
b. Read the bank of questions including their criteria, the group to which they belong, their answers, and the scores;
c. Check that there is at least one question;
d. Shuffle the questions between themselves;
e. Sort the questions according to criteria or scores;
f. Prepare the list of questions;
g. Read the next question;
h. If there is a next question, continue; otherwise, stop;
i. Send a notification containing the previously read question;
j. Wait for the user's answer;
k. Evaluate and put a score at the answer provided;
l. Save the score obtained so that it is linked to the previously selected question or to the group to which the selected question belongs to be reused at step b;
m. Display the answer to the user;
n. Wait for the user to ask to display the next question;
o. Return to step g.

In another aspect, the invention applies with the use of notification associated with a countdown timer wherein the user answers multiple-choice questions.
a. Pre-register a bank of multiple-choice questions including their criteria, the group to which they belong, their answers, and the scores;
b. Read the bank of multiple-choice questions including their criteria, the group to which they belong, their answers, and the scores;
c. Check that there is at least one multiple-choice question;
d. Shuffle the multiple-choice questions between themselves;
e. Sort the multiple-choice questions according to criteria or scores;
f. Prepare the list of multiple-choice questions;
g. Read the next multiple-choice question;
h. If there is a next multiple-choice question, continue; otherwise, stop;
i. Start the countdown;
j. Wait for the end of the countdown;
k. Send a notification containing the previously read multiple-choice question;
l. Replace the multiple-choice question in the list of current multiple-choice questions at the user's request;
m. Wait for the user to select the answer;
n. Evaluate and put a score at the answer;
o. If the answer is correct and the user wishes to review it by using the mechanism allowing them to do it, place the question back in the list being read and return to step g;
p. Save the score obtained so that it is linked to the previously selected multiple-choice question or to the group to which the selected multiple-choice question belongs to be reused at step b;
q. In the event of a wrong answer, subtract zero or more points from the score linked to the question corresponding to the answer given or to the group to which the question corresponding to the answer given belongs to be reused later at step b;
r. Display the answer to the user;
s. Return to step g.

In another aspect, the invention applies without display delay and is displayed in the space of the user's application.
a. Pre-register a bank of questions including their criteria, the group to which they belong, their answers, and the scores;
b. Read the bank of questions including their criteria, the group to which they belong, their answers, and the scores;
c. Check that there is at least one question;
d. Shuffle the questions between themselves;
e. Sort the questions according to criteria or scores;
f. Prepare the list of questions;
g. Read the next question;
h. If there is a next question, continue; otherwise, stop;
i. Display the previously read question;
j. Wait for the user's answer;
k. Evaluate and put a score at the answer provided;
l. Save the score obtained so that it is linked to the previously selected question or to the group to which the selected question belongs to be reused at step b;
m. Display the answer to the user;
n. Return to step g.

In a further aspect, the invention will use a countdown and notifications as display mode;

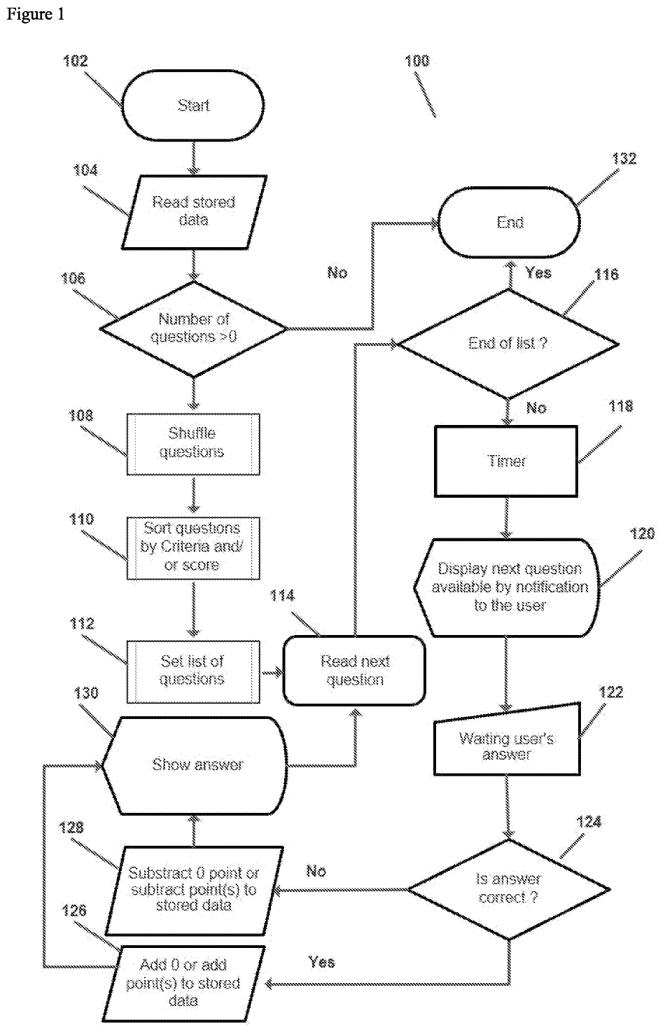

FIG. 1 illustrates an example of method 100 of information retention of learned material which displays questions to the user in the form of a notification according to the degree of success of the answers previously obtained with a countdown. The reader skilled in the art will appreciate that many other alternative methods come within the scope of the invention, some of which are variations of method 100;

In the following text, the epithet “system” applies to a computer system;

Method 100 is made to be implemented in a system;

The method starts at step 102. At step 104, the system reads the questions that have been saved according to several criteria. At step 106, the system checks if there is at least one available question. If at step 106 there are zero questions, the system goes to final step 132. If at step 106 there is at least one question, the system goes to step 108. At step 108, the system shuffles the questions. At step 110, the system sorts the questions according to criteria or scores. At step 112, the system lists the questions that will be displayed based on the sorting done at step 110. At step 114, the system reads the next question. At step 116, the system checks that it is not at the end of the list. If at step 116, it is at the end of the list, the system goes to final step 132. If at step 116 it is not at the end of the list, the system goes to step 118. At step 118, the system determines the time-out for displaying the next notification that will contain the question. At step 120, the system displays the question as a notification. At step 122, the system waits a certain time for the user's answer. At step 124, the system validates the user's answer. Following a correct answer from the user, the system proceeds to step 126 wherein zero or more points will be added to the score of the question or of the group to which the question belongs. Following a wrong answer or in the absence of an answer from the user, the system proceeds to step 128 wherein zero or more points will be subtracted from the score of the question or of the group to which the question belongs. At step 130, the system shows the answer. The system returns to step 114 wherein it follows the steps described above again;

In the following text, the epithet “multiple-choice question” means, without limiting, a question presenting several answer choices to the user. When possible, each of the answer choices offered is a subset of the answers to the other questions present in the database and which share the same criteria as the “multiple-choice question” itself;

Method 200 is made for system implementation;

The method starts at step 202. At step 204, the system reads the multiple-choice questions that have been saved according to a number of criteria. At step 206, the system checks whether at least one multiple-choice question is available. If there is not at least one question, the system goes to final step 240. If there is at least one multiple-choice question, the system goes to step 208. At step 208, the system shuffles the multiple-choice questions. At step 210, the system sorts the questions according to criteria or scores. At step 212, the system lists the multiple-choice questions displayed based on the sorting done at step 210. At step 214, the system reads the next question. At step 216, the system checks that it is not at the end of the list. If at step 216 it is at the end of the list, the system goes to final step 240. If at step 216 it is not at the end of the list, the system goes at step 218. At step 218, the system determines the time-out for displaying the next notification that will contain the multiple-choice question. At step 220, the system displays the multiple-choice question as a notification. At step 222, the system waits for the user's answer. At step 224, the system checks whether the user wishes to review the question. If at step 224 the user wishes to review the question, the system proceeds to step 226. At step 226, the system reinserts the multiple-choice question into the list of multiple-choice questions to be read so that it can be presented to the user again and proceeds to step 228. If at step 224 the user does not wish to review the question, the system proceeds to step 228. At step 228, the system validates the user's answer. If the answer evaluated at step 228 is correct, the system proceeds to step 230 wherein zero or more points will be added to the score of the multiple-choice question or of the group to which the multiple-choice question belongs and then proceeds to step 238. If the answer evaluated at step 228 is bad, the system proceeds to step 232 wherein zero or several points will be subtracted from the score of the multiple-choice question or of the group to which the choice question belongs. The system proceeds to step 234 wherein it checks whether a link exists between the incorrect answer given and another question that is present in the database. If at step 234 there is no link between the incorrect answer from the user and another question in the database, the system goes to step 238. If at step 234 there is a link between the user's incorrect answer and another question in the database, the system goes to step 236 wherein zero to more points will be subtracted from the score of the question corresponding to the wrong given answer or of the group to which the question corresponding to the given incorrect answer belongs and then proceeds to step 238. At step 238, the system shows the answer and the questions associated with the other proposed answers as answer choices. The system returns to step 214 wherein it follows the steps described above again;

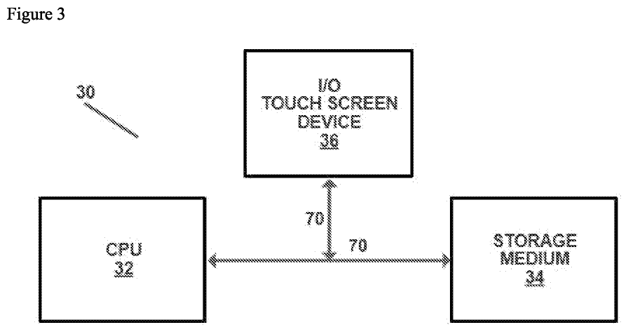

FIG. 3 in reference schematizes a mobile computer system 30 which implements a method 100 or 200 of information retention learned displaying questions to the user according to the degree of success of the answers previously obtained. System 30 can be designed as having a touch screen 36 such as, without limitation, a smartphone or a tablet which accesses its data stored locally on the storage medium 34 and which manages all the processing by its processing unit 32. All communication passes on the same data bus Questions and answers are displayed and answered through the same input and output device 36. The representation made presents data hosted locally on the same system, however, the invention also covers data hosted on a remote peripheral or a server. The description given above should not restrict the scope of the claims of currently known computer systems and data hosting;

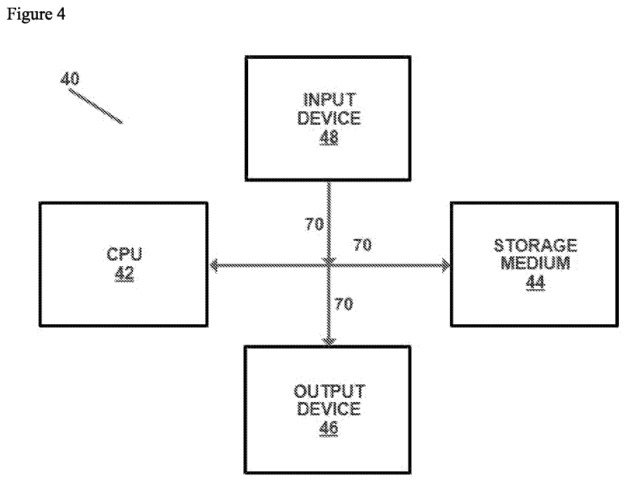

FIG. 4 in reference schematically shows a computer system 40 which implements a method 100 or 200 of information retention learned which displays questions to the user according to the degree of success of the answers previously obtained. The system 40 can be conceived as a personal computer that accesses its data stored locally on the storage medium 44 and which manages all the processing by its processing unit 42. All the communication passes on the same data bus 70. The questions are displayed on the output device 46 and the answers are entered using the input device 48. Input 48 and output 46 peripherals should be understood in a broad sense and the description given above should not restrict the scope of the claims of currently known personal computer systems and input and output peripherals;

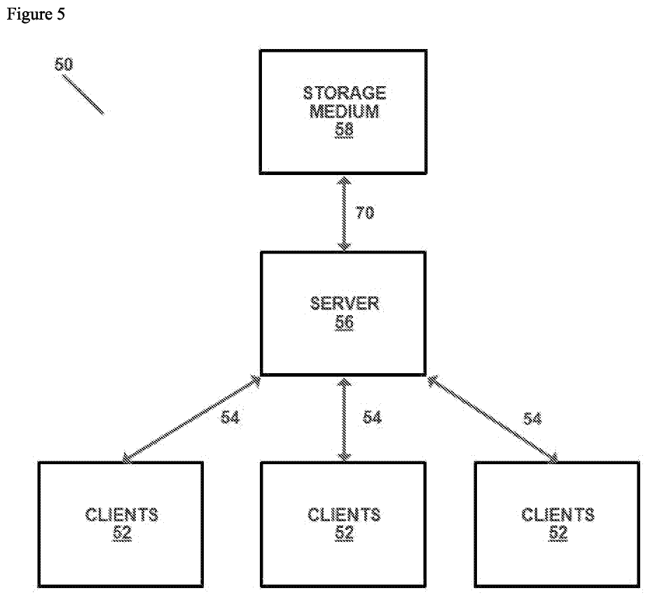

FIG. 5 in reference schematically shows a system 50 which implements a method 100 or 200 of information retention learned which displays questions to the user according to the degree of success of the answers previously obtained. In the system 50, it is the server 56 which manages all the processing, including access by the data bus 70 to the data stored on the storage medium 58, the client's 52 are computer systems that serve as terminals, that is, they allow users to view and answer questions. In system 50, clients 52 and server 56 are part of the same network 54. However, it is within the scope of the invention that server 56 is on another network or is remote. The above description should not restrict the scope of the claims of currently known client-server systems. Although the diagram shows a server and three clients, it is also within the scope of the invention to have several servers and countless clients.

1. A method of information retention learned which displays questions to the user according to the degree of success obtained in answering them is presented; said method includes the following steps:
a. Pre-register a bank of questions including their criteria, the group to which they belong, their answers, and the scores;
b. Read the bank of questions including their criteria, the group to which they belong, their answers, and the scores;
c. Check that there is at least one question;
d. Shuffle the questions between themselves;
e. Sort the questions according to criteria or scores
f. Prepare the list of questions;
g. Read the next question;
h. If there is a next question, continue otherwise stop;
i. Start the countdown;
j. Wait for the end of the countdown;
k. Display the previously read question;
l. Wait for the user's answer or timeout;
m. Return the question into the current question list at the user's request;
n. Evaluate and put a score at the answer;
o. Save the score so that it is linked to the question or group to which the question belongs or to the question linked to the answer or to the group to which the question linked to the answer belongs to be reused at step b;
p. Display the answer to the user
q. Return to step g;

2. A method as defined in claim 1 wherein the database contains fields representing different criteria according to the field of teaching;

3. A method as defined in claim 1 wherein the database contains fields representing different criteria making it possible to establish an order of priority;

4. A method as defined in claim 1, 2, or 3 which accesses a database containing questions;

5. A method as defined in claim 4 wherein the questions are closed questions;

6. A method as defined in claim 4 wherein the questions are completion questions;

7. A method as defined in claim 4 wherein the questions are matching questions;

8. A method as defined in claim 4 wherein the questions are multiple-choice questions;

9. A method as defined in claim 4, 5, 6, 7, or 8 wherein the database contains the answers to the questions;

10. A method as defined in claim 9 wherein the answer choices to the multiple-choice questions are a subset of the answers to the other questions present in the database and which may or may not share the same criteria as the multiple-choice question;

11. A method as defined in claim 9 wherein the answer choices to the multiple-choice questions are not a subset of the answers to the other questions present in the database;

12. A method as defined in claim 9, 10, or 11, wherein the database contains a field linked to the question or to a group of questions making it possible to save several points used for weighting;

13. A method as defined in claim 12 wherein the points awarded represent a fraction of a predetermined maximum score value;

14. A method as defined in claim 13 wherein the number of points added or subtracted is less than or equal to a predetermined maximum value;

15. A method as defined in claim 14 wherein it is possible to add points to those already present in the database;

16. A method as defined in claim 15 wherein the cumulative total of added points is less than or equal to the predetermined maximum value;

17. A method as defined in claim 14 wherein it is possible to subtract points from those already present in the database;

18. A method as defined in claim 17 wherein the cumulative total of subtracted points is greater than or equal to a predetermined minimum value;

19. A method as defined in claim 14, 16, or 18 wherein the criteria make it possible to sort, calculate the points, categorize, group, and choose the type of question to be presented;

20. A method as defined in claim 14, 16, or 18 wherein the criteria make it possible to sort, calculate the points, categorize, group, and choose the order in which the questions will be presented;

21. A method as defined in claim 16, 18, 19, or 20 wherein the database contains a complementary field making it possible to differentiate similar questions;

22. A method as defined in claim 21 wherein the complementary field can be displayed simultaneously alongside as the question;

23. A method as defined in claim 22 wherein the database contains a field indicating that the material allowing to answer the question has been seen;

24. A method as defined in claim 23 wherein the questions are arranged in a random order;

25. A method as defined in claim 24 which creates a list of questions grouped and sorted by criteria or by scores;

26. A method as defined in claim 25 wherein the list contains the questions which will be displayed;

27. A method as defined in claim 26 wherein the list of questions is scanned from start to finish;

28. A method as defined in claim 27 wherein a question that has already been read from the list and displayed can be reinserted into this same list in order to be read and displayed again;

29. A method as defined in claim 28 wherein the list is scanned and the questions are read one by one when their display is required;

30. A method as defined in claim 29 wherein the questions are displayed within a predefined time interval;

31. A method as defined in claim 30 wherein the time interval can be changed at any time by the user;

32. A method as defined in claim 31 wherein the questions are displayed on the user's screen;

33. A method as defined in claim 31 wherein the questions are displayed through a notification;

34. A method as defined in claim 31, 32, or 33 wherein the questions can be of the written type;

35. A method as defined in claim 31, 32, or 33 wherein the questions can be of the sound type;

36. A method as defined in claim 31, 32, or 33 wherein the questions can be of the animation type;

37. A method as defined in claim 31, 32, or 33 wherein the questions can be of the video type;

38. A method as defined in claim 32, 33, 34, 35, 36, or 37 wherein the answer can be given by selecting an answer choice;

39. A method as defined in claim 32, 33, 34, 35, 36, or 37 wherein the answer can be given in writing;

40. A method as defined in claim 32, 33, 34, 35, 36, or 37 wherein the answer can be given orally;

41. A method as defined in claim 31, 38, 39, or 40 wherein the user can indicate that they wish to review the question when answering it;

42. A method as defined in claim 41 wherein the question is reinserted into the list at the user's request;

43. A method as defined in claim 42 wherein zero to more points are added following a correct answer;

44. A method as defined in claim 43 wherein the number of points is added to the points already entered as defined in claims 14, 15, and 16;

45. A method as defined in claim 44 wherein the number of points added is related to the question or to a group of questions to which the question belongs;

46. A method as defined in claim 42 wherein zero to more points are subtracted as a result of a wrong answer;

47. A method as defined in claim 46 wherein the number of points is subtracted from the points already entered as defined in claims 14, 17, and 18;

48. A method as defined in claim 47 wherein the number of points subtracted is related to the question or to a group of questions to which the question belongs;

49. A method as defined in claim 48 wherein the number of points subtracted is related to the question to which the answer is related or to a group of questions to which the answer is related;

50. A method as defined in claim 41, 45, 48, or 49 wherein the answer to the question or the questions linked to the answer choices of the multiple-choice questions are displayed following the answer to the user;
